(19) United States
(12) Patent Application Publication
(10) Pub. No.: US 2026/0084085 A1
(43) Pub. Date: Mar. 26, 2026

(54) SEPARATION METHOD

(71) Applicant: L'Air Liquide, Societe Anonyme pour l'Etude et l’Exploitation des Procedes Georges Claude, Paris (FR)

(72) Inventors: Mathieu LECLERC, Champigny-sur-Marne (FR); Guillaume RODRIGUES, Champigny-sur-Marne (FR); Laurette MADELAINE, Champigny-sur-Marne (FR)

(21) Appl. No.: 19/110,928

(22) PCT Filed: Sep. 4, 2023
(86) PCT No.: PCT/EP2023/074167

§ 371 Date: Mar. 12, 2025

(30) Foreign Application Priority Data
Sep. 12, 2022 (FR) FR2209108

(51) Int. Cl. B01D 53/00; B01D 53/047; B01D 53/26

(52) U.S. Cl. CPC B01D 53/002; B01D 53/047; B01D 53/261; B01D 53/265; B01D 2257/504; B01D 2258/0283

(57) ABSTRACT

Method for producing a gas enriched in carbon dioxide from a feed synthesis gas comprising at least one condensable component and in particular hydrogen, characterized in that the method further comprises: a step referred to as a desaturation step during which at least a portion of the condensable component contained in the feed synthesis gas is, upstream of said pressure swing adsorption separation unit, condensed by cooling to a temperature below 10° C., in particular below or equal to 5° C., and separated, producing said desaturated synthesis gas and at least one condensate; the feed synthesis gas exchanging heat with the desaturated synthesis gas so as to heat said desaturated synthesis gas.

### CROSS-REFERENCE TO RELATED APPLICATIONS

This application is a § 371 of International PCT Application PCT/EP2023/074167, filed Sep. 4, 2023, which claims § 119(a) foreign priority to French patent application FR 2209108, filed Sep. 12, 2022.

### BACKGROUND

### Field of the Invention

The present invention relates to a process for producing a carbon dioxide-enriched gas from a synthesis gas. The invention also concerns an installation for implementing such a process.

### Related Art

Carbon dioxide capture processes are used in the production of hydrogen from synthesis gas from a steam methane reforming and/or partial methane oxidation reaction, most often combined with a shift reaction of carbon monoxide to steam. To separate and purify (and possibly capture) the carbon dioxide contained in the synthesis gas cryogenically, for example, it is necessary to dry the feed gas of a separation and purification unit to remove condensable components (mainly water, but also possibly methanol or ammonia). The aim for example is to avoid solidification of water to ice when the separation and purification unit is a cryogenic unit in which the carbon dioxide is separated and purified by partial condensation. One drying unit typically used is a unit for drying by adsorption such as by temperature swing adsorption (also called a TSA unit).

Synthesis gas (or syngas) consists typically of hydrogen at a level of 75%. The remaining 25% is divided between carbon dioxide and methane, nitrogen, residual carbon monoxide and condensable components, including especially water. The synthesis gas is first passed through a pressure swing adsorption separation unit (also called a PSA unit) to separate firstly the hydrogen and secondly a carbon dioxide-enriched residual gas. The synthesis gas from the steam reforming reaction, the partial methane oxidation reaction and/or potentially the steam shift reaction is normally cooled to a temperature around 30° C. or 40° C. before being sent to the PSA unit. The gas typically arrives at the PSA unit at a pressure between 20 and 60 bara, saturated with water.

The residual gas must be compressed, cooled to allow its drying and ultimately the separation and purification of the carbon dioxide in the separation and purification unit. Compression takes place typically to 50 bara. The other gases in the residual gas are, for example, burned in the furnace where the reforming reaction takes place.

Cooling the residual gas during compression thereof reduces the energy consumption of the compression step. A compression and cooling device comprising one or more compression stages and what are termed intermediate cooling heat exchangers located between two compression stages for cooling the compressed residual gas is therefore used. The intermediate heat exchangers are also called intercoolers. The cooling exchangers typically use water as a cooling fluid, which can then be cooled in cooling towers. A problem occurs when compressing and cooling the residual gas in these cooling exchangers: the residual gas can reach its dew point and the condensable components are condensed. One or more condensates, composed mainly of water and dissolved carbon dioxide, are then generated. They are particularly acidic (pH ˜3).

Various strategies have been implemented in the prior art to minimize the costs associated with the compression of the residual gas.

The use of corrosion-resistant materials, such as stainless steel, for the compression device, especially for the intermediate exchangers, allows the residual gas to be dried at a high pressure level without risk of corrosion of the materials by the condensable components. The drying cost is also reduced by virtue of the relatively high pressure, and the operating expenses correspondingly. However, such materials lead to an increase in capital expenditure.

Drying the residual gas upstream of the compression allows less expensive materials such as carbon steel to be used for the compression device, as the condensable components have been removed. However, the drying cost is higher because of the large amount of condensable components to be removed, the large volume flow rate and the low-pressure adsorption isotherms.

Drying the residual gas at an intermediate compression stage is a known compromise, allowing the use of carbon steel at the compression stages downstream of the drying unit and reducing the cost of drying, which takes place at a higher pressure. The drying unit (or dryer) is typically arranged at a compression stage of approximately 10 bara. It is also known practice to make use, upstream of the drying unit, of a device for condensing condensable components by cooling to treat the residual gas obtained from the PSA unit. A device of this kind, using chilled water, for example, maximizes condensation upstream of the dryer. However, in order to maintain carbon steel at the compression stages upstream of the drying unit too, it is necessary to maintain the residual gas at a temperature of 7 to 10° C. above the dewpoint temperature of the condensable components. This is a safety margin against potential temperature fluctuations that can lead to accidental condensation of the condensable components. Keeping the residual gas at a higher temperature in this way results in compression taking place at a higher temperature, which consumes more energy.

It is generally difficult to manage the risks of condensation during this compression step, especially at the upper compression stages, upstream of the drying unit where appropriate. Furthermore, when the temperature drops in winter, the risk of accidental condensation increases further. There is therefore a need for a process for producing a carbon dioxide-enriched gas with fewer condensation-related constraints and with a lower electricity consumption.

### SUMMARY OF THE INVENTION

A subject of the invention is thus a process for producing a carbon dioxide-enriched gas from a feed synthesis gas comprising at least one condensable component, the feed synthesis gas comprising especially hydrogen, the process comprising the following steps:
a) introduction into a unit for separation by pressure swing adsorption (PSA unit) of a de-saturated synthesis gas obtained from the feed synthesis gas;
b) separation by the pressure swing adsorption separation unit of the de-saturated synthesis gas into a first fraction and a carbon dioxide-enriched residual gas;
c) compression of the residual gas with at least two compression stages and cooling of the compressed residual gas at at least one intermediate compression stage;
characterized in that the process further comprises:
a desaturation step during which at least a portion of the at least one condensable component contained in the feed synthesis gas is condensed, upstream of said pressure swing adsorption separation unit, by cooling to a temperature of less than 10° C., especially less than or equal to 5° C., and separated, producing said de-saturated synthesis gas and at least one condensate;
the feed synthesis gas undergoing heat exchange with the de-saturated synthesis gas so as to heat said de-saturated synthesis gas upstream of the pressure swing adsorption separation unit.

Contrary to what is known from the prior art, in which the device for condensing the components condensable by cooling treats the residual gas to maximize the condensation of said components upstream of a dryer, the invention proposes treating the feed gas of the PSA unit. It is known from the prior art that cooling the feed gas of a PSA unit in a thorough manner does not contribute anything from the point of view of this unit, or is even to the detriment of its operation.

Removing at least a portion of the condensable component(s) from the PSA unit feed gas reduces the risks of accidental condensation of said component(s) during step c), from a certain compression stage onwards. Heating the PSA unit feed gas, cooled thoroughly during the desaturation step, brings it back to temperature ranges that are compatible with proper operation of the PSA unit.

According to one implementation of the process, the feed synthesis gas comprises between 70% and 80% of hydrogen and between 20% and 30% of other compounds, including carbon dioxide, the at least one condensable component, possibly residual methane and residual carbon monoxide, and for example nitrogen. In particular, the first fraction is enriched in hydrogen.

According to one implementation of the process, the at least one condensable component is chosen from water, ammonia and/or methanol.

According to one implementation of the process, the de-saturated synthesis gas comprises between 150 and 700 ppmv of condensable component, especially between 150 and 700 ppmv of water.

According to one implementation of the process, in the desaturation step, the condensation of the at least one condensable component is performed by cooling of the feed synthesis gas using a refrigerant fluid. The refrigerant fluid is more particularly chosen from chilled water, cold air or a coolant fluid.

According to one implementation of the process, the feed synthesis gas undergoes heat exchange with the de-saturated synthesis gas in an economizer exchanger and a minimum temperature difference between the feed synthesis gas and the de-saturated synthesis gas, within the economizer exchanger, is between 2 and 10° C., especially between 5 and 10° C. A temperature of the de-saturated synthesis gas is especially between 20 and 40° C., especially between 30 and 40° C.

According to one implementation of the process, the first fraction is enriched in hydrogen.

According to one implementation, the process comprises a step d) during which the residual gas is dried by adsorption so as to separate residual condensable component from the residual gas.

According to one implementation of the process, the residual gas is dried during step d), downstream of the compression step c). Alternatively, the residual gas is dried during step d), at an intermediate compression stage during step c).

According to one implementation of the process, in step d), the residual gas is dried by adsorption in a unit for drying the residual gas by adsorption and the process comprises a step of regeneration of said unit for drying the residual gas by adsorption.

According to one implementation, the process comprises downstream of step c), and possibly downstream of step d) when there is such a step, a step e) during which the carbon dioxide is separated from the residual gas in order to be captured or sequestered. The carbon dioxide is, especially, separated by partial condensation during step e), the carbon dioxide being at least partially condensed. Alternatively, the carbon dioxide is separated from the residual gas using a membrane in a membrane unit. Alternatively, the carbon dioxide is separated by a combination of partial condensation separation and separation using a membrane.

According to one implementation, the process comprises, upstream of the desaturation step, a step of cooling the feed synthesis gas, especially using a cooling fluid, such as cooling water or air. The step of cooling the feed synthesis gas is carried out especially in at least one heat exchanger known as the feed heat exchanger and arranged upstream of the desaturation step.

According to one implementation, the process comprises the following steps:
measurement of a temperature of the de-saturated synthesis gas,
comparison of the measured temperature of the de-saturated synthesis gas with a minimum setpoint temperature of the de-saturated synthesis gas introduced into the pressure swing adsorption separation unit,
if the measured temperature of the de-saturated synthesis gas is lower than the minimum setpoint temperature, regulation of the temperature of the de-saturated synthesis gas by reduction in the cooling of the feed synthesis gas in the feed heat exchanger.

A further subject of the invention is an installation for production of a carbon dioxide-enriched gas from a feed synthesis gas comprising at least one condensable component, the feed synthesis gas comprising especially hydrogen, the installation comprising:
a pressure swing adsorption separation unit (PSA unit) configured to separate a de-saturated synthesis gas, obtained from the feed synthesis gas, into a first fraction and a carbon dioxide-enriched residual gas;
a compression device arranged downstream of the pressure swing adsorption separation unit, the compression device comprising at least two stages for compressing the residual gas and at least one intermediate exchanger for cooling the compressed residual gas at an intermediate compression stage;
characterized in that the installation comprises:
upstream of the pressure swing adsorption separation unit, a condensation by cooling and separation device configured to condense and separate at least a portion of the condensable component contained in the feed synthesis gas and produce the de-saturated synthesis gas and at least one condensate;
an economizer exchanger arranged to bring about heat exchange between the feed synthesis gas and the de-saturated synthesis gas.

According to one embodiment, the pressure swing adsorption separation unit is configured to separate the de-saturated synthesis gas into a first hydrogen-enriched fraction and a carbon dioxide-enriched residual gas.

According to one embodiment, the installation comprises a residual gas adsorption drying unit configured to separate residual condensable component from the residual gas.

According to one embodiment, the installation comprises, downstream of the compression device, in particular, where appropriate, downstream of the residual gas drying unit, a separation and purification unit configured to separate the carbon dioxide from the compressed and optionally dried residual gas and capture or sequester said carbon dioxide. The separation and purification unit comprises especially a unit configured to separate the carbon dioxide from the residual gas by partial condensation. Alternatively, the separation and purification unit comprises a membrane unit configured to separate the carbon dioxide from the residual gas using a membrane. Alternatively, the separation and purification unit comprises, for the separation of the carbon dioxide from the residual gas, a combination of a unit configured to separate the carbon dioxide by partial condensation and a membrane unit.

According to one embodiment, the condensation by cooling and separation device comprises:
a bi-fluid exchanger comprising a section for circulating the feed synthesis gas and a section for circulating a refrigerant fluid, arranged to be in heat exchange with the section for circulating the feed synthesis gas, to cool the feed synthesis gas, to condense the condensable compounds and to produce the de-saturated synthesis gas and the at least one condensate;
a condensate separation device configured to separate the at least one condensate from the de-saturated synthesis gas.

The bi-fluid exchanger is in particular a shell and tube exchanger, the section for circulating the refrigerant fluid being defined by the internal space of at least one tube contained in a shell and the section for circulating the feed synthesis gas being defined by a space between the shell and the at least one tube. The device for separating the at least one condensate is, for example, a phase separator can. The condensation by cooling and separation device comprises especially a refrigerating assembly for cooling the refrigerant fluid.

According to one embodiment, the economizer exchanger comprises:
a first section for circulating the feed synthesis gas;
a second section for circulating the de-saturated synthesis gas, arranged to be in heat exchange with the first section.

The economizer exchanger is in particular a shell and tube exchanger, the section for circulating the de-saturated synthesis gas being defined by the internal space of at least one tube contained in a shell and the section for circulating the feed synthesis gas being defined by a space between the shell and the at least one tube.

According to one embodiment, the installation comprises, upstream of the first section of the economizer exchanger, at least one feed heat exchanger, arranged to regulate the temperature of the feed synthesis gas. The feed heat exchanger comprises in particular a feed synthesis gas circulation channel and a channel for circulation of a cooling fluid, such as cooling water or air, the cooling fluid circulation channel being arranged to be in heat exchange with the feed synthesis gas circulation channel.

According to one embodiment, the compression device is at least partly made of a carbon steel alloy, especially the at least one intermediate exchanger of said compression device.

According to one embodiment, the adsorption drying unit is arranged downstream of the compression device. Alternatively, the adsorption drying unit is arranged at an intermediate compression stage of the compression device. The adsorption drying unit is especially a regenerable unit such as a temperature swing adsorption drying unit (TSA unit).

The installation for production of a carbon dioxide-enriched gas can be used to implement the process as described above.

The invention also concerns a process for revamping an installation for production of a carbon dioxide-enriched gas from a feed synthesis gas comprising at least one condensable component, the feed synthesis gas comprising especially hydrogen, the installation comprising:
a pressure swing adsorption separation unit configured to separate a de-saturated synthesis gas, obtained from the feed synthesis gas, into a first fraction and a carbon dioxide-enriched residual gas;
a compression device arranged downstream of the pressure swing adsorption separation unit, the compression device comprising at least two stages for compressing the residual gas and at least one intermediate exchanger for cooling the compressed residual gas at an intermediate compression stage;
the process comprising the steps of:
arranging upstream of the pressure swing adsorption separation unit a condensation by cooling and separation device configured to condense and separate at least a portion of the at least one condensable component contained in the feed synthesis gas and produce the de-saturated synthesis gas and at least one condensate;
arranging a first circulation section of an economizer exchanger upstream of the condensation by cooling and separation device for the circulation of the feed synthesis gas and arranging a second circulation section of the economizer exchanger downstream of the condensation by cooling and separation device and upstream of the pressure swing adsorption separation unit, for circulation of the de-saturated synthesis gas.

### BRIEF DESCRIPTION OF THE FIGURES

FIG. 1 represents an installation for production of a carbon dioxide-enriched gas from a feed synthesis gas 16 (or syngas).

### DETAILED DESCRIPTION OF THE INVENTION

In the embodiment represented, the feed synthesis gas 16 is produced in a unit for the purpose of hydrogen production and comprises hydrogen. It is typically a synthesis gas comprising between 70% and 80% of hydrogen and between 20% and 30% of other compounds, including carbon dioxide, at least one condensable component (a plurality in this embodiment: “ the condensable components”), unconverted methane, unconverted carbon monoxide and nitrogen. The feed synthesis gas is for example saturated with condensable components or unsaturated.

The synthesis gas is treated in a pressure swing adsorption separation unit 1 (otherwise called a PSA unit) to separate the synthesis gas into a first fraction enriched in hydrogen and a residual gas 2 enriched in carbon dioxide. The PSA unit 1 comprises a first outlet for the first hydrogen-enriched fraction (hydrogen PSA) and a second outlet for the residual gas 2 produced. A line feeds synthesis gas to the PSA unit 1. The pressure swing adsorption separation unit 1 will recover up to 90% of the hydrogen initially contained in the synthesis gas.

Upstream of the pressure swing adsorption separation unit 1, the feed synthesis gas 16 is separated from at least a portion of its condensable components (here mainly water) in a condensation by cooling and separation device which produces a de-saturated synthesis gas 17 and condensates 6. The de-saturated synthesis gas 17 comprises especially between 150 and 700 ppmv of water. This device comprises a bi-fluid exchanger 3 which itself comprises a circulation section 4 for the feed synthesis gas 16, arranged on the line 16 for feeding the PSA unit 1 with synthesis gas, and a circulation section 5 for a refrigerant fluid. These two sections are arranged in the bi-fluid exchanger 3 so as to be in heat exchange with each other. The bi-fluid exchanger 3 thus enables heat exchange between the refrigerant fluid and the feed synthesis gas 16, the refrigerant fluid cooling the feed synthesis gas 16 to a temperature of less than 10° C., especially to a temperature of less than or equal to 5° C. This cooling therefore brings about the condensation of a portion of the condensable components contained in the feed synthesis gas 16, thus giving the condensates 6. The PSA unit 1 then treats a gas that has been freed of a portion of its condensable components, which simplifies its regeneration. The risk of accidental condensation during a compression step of the residual gas 2 produced by the PSA unit 1 is thus reduced. The refrigerant fluid is, for example, chilled water, cold air or a coolant fluid. The refrigerant fluid is supplied to the bi-fluid exchanger 3 after having been cooled by a refrigerating assembly (not represented). The bi-fluid exchanger 3 is typically a shell and tube exchanger, the section for circulating the refrigerant fluid being defined by the internal space of at least one tube contained in a shell and the section for circulating the synthesis gas being defined by a space between the shell and the at least one tube.

The condensates 6 are then separated in a condensate separation device 6. The condensate separation device 6 and the bi-fluid exchanger 3 can be integrated, in which case the condensate separation 6 takes place in the body of the exchanger itself or else the heat exchange takes place in the condensate separation device 6. Alternatively, the condensate separation device 6 may constitute a separate unit from the bi-fluid exchanger 3 within the condensation by cooling and separation device. The condensate separation device 6 is, for example, a phase separator can.

The installation comprises an economizer exchanger 7 arranged to bring about heat exchange between the feed synthesis gas 16 and the de-saturated synthesis gas 17. For this purpose, the economizer exchanger 7 comprises a first circulation section 8 for the feed synthesis gas 16, arranged on an upstream portion (with respect to the condensation by cooling and separation device) of the feed line of the PSA unit 1. The economizer exchanger 7 further comprises a second circulation section 9 for the de-saturated synthesis gas 17, arranged on a portion of the feed line of the PSA unit 1 that is downstream of the condensation by cooling and separation device. These two sections are arranged in the economizer exchanger 7 so as to be in heat exchange with one another. The economizer exchanger 7 thus allows a heat exchange between the feed synthesis gas 16 (not de-saturated) and the de-saturated synthesis gas 17. The minimum temperature difference between the two circulation sections of the economizer exchanger 7 (minimum temperature approach) is between 2 and 10° C., especially between 5 and 10° C. The feed synthesis gas 16 thus heats the de-saturated synthesis gas 17 before it is sent to the PSA unit 1. The economizer exchanger 7 is typically a shell and tube exchanger, the section for circulating the de-saturated synthesis gas 17 being defined by the internal space of at least one tube contained in a shell and the section for circulating the feed synthesis gas 16 being defined by a space between the shell and the at least one tube. The adverse impact of the thorough cooling caused by the condensation by cooling and separation device upstream of the unit is thus avoided.

In a case where the economizer exchanger 7 is not sufficient to compensate for the impact of the cooling on the PSA unit 1, it is proposed to regulate the temperature of the feed synthesis gas 16, obtained from a reforming unit and/or from a partial oxidation unit, by means of a heat exchanger 15 arranged upstream of the economizer exchanger 7 and the condensation by cooling and separation device, from the point of view of the process (feed exchanger 15). A typical regulation comprises a step of measuring a temperature of the de-saturated synthesis gas 17 and a step of comparing this temperature with a minimum setpoint temperature of the de-saturated synthesis gas 17 entering the pressure swing adsorption separation unit. If the temperature of the feed synthesis gas 16 is too low, i.e. less than the minimum setpoint temperature, it is possible to limit the cooling of the feed synthesis gas 16 by reducing the flow rate of a cooling fluid (chosen from cooling water or air) circulating in the feed exchanger 15 and/or by bypassing said feed exchanger 15 with a portion of the synthesis gas (part of the feed synthesis gas 16 is then no longer cooled and is mixed with the part that is cooled in the heat exchanger 15). The operation is carried out until the measured temperature of the de-saturated synthesis gas 17 is greater than or equal to the minimum setpoint temperature. A calculation and control unit (not represented) makes it possible to carry out the measurements and calculations necessary for such regulation.

Since the economizer exchanger 7 provides a large part of the cooling, the condensation by cooling and separation device serves only to adjust the cooling temperature, and its size and its energy consumption can be reduced. The bi-fluid exchanger 3 then only needs to provide the condensation energy for the condensable components, but not the cooling energy for the other compounds in the synthesis gas, such as hydrogen.

The de-saturated synthesis gas 17 is therefore supplied to the PSA unit 1, at a temperature typically of between 30 and 40° C. and a pressure of between 20 and 60 bara (bar absolute). The PSA unit 1 then produces the residual gas 2. The latter is then compressed in a compression device 10. The compression device 10 comprises two stages 11a; 11b or levels of compression of the residual gas 2. In other embodiments, the compression device 10 may, however, comprise more than two compression stages. After compression to the first compression level, the residual gas 2 is cooled by an intermediate exchanger 12 for cooling (intercooler) the compressed residual gas at an intermediate compression stage 11a. The fact that at least a portion of the condensates have been removed downstream of the PSA unit makes it possible to cool the residual gas 2 further without any risk of condensation in the intermediate exchanger 12. The compression device 10 then consumes less energy to compress the residual gas 2. In the intermediate exchanger 12, water cooled in cooling towers (not represented) typically serves as cooling fluid. The intermediate exchanger 12 is at least partly made of carbon steel alloy, this being made possible by the reduced risks of condensation. Such materials are less expensive than stainless steel. In particular, such an alloy is not designed to withstand compounds with a pH of less than 4. A compression stage corresponds to a level of compression reached in the compression device 10 at the outlet of a compression element, such as a compression wheel. An intermediate compression stage is then situated between two compression elements of the compression device 10.

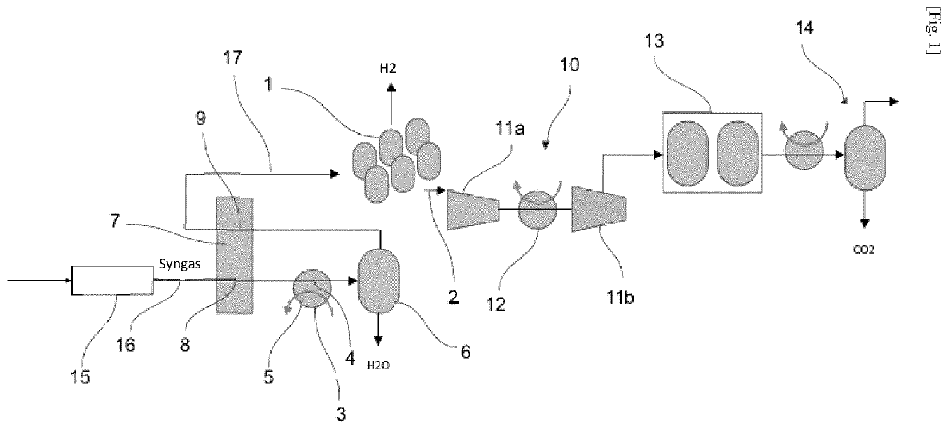

In one embodiment, not represented, the compressed residual gas obtained from the compression device 10 is cooled in a final cooling exchanger. The compressed residual gas obtained from the compression device 10 is sent to a temperature swing adsorption drying unit 13 (TSA unit) in which the residual gas is freed, by adsorption, of the residual condensable components it contains. The TSA unit 13 cyclically undergoes production steps during which the residual gas is dried and regeneration steps during which the adsorbent is regenerated. In the embodiment of FIG. 1, drying by the TSA unit 13 takes place after the compression step, downstream of the compression device 10, at a pressure of about 50 bara. In another embodiment, drying by the TSA unit 13 can also take place at an intermediate compression stage 11a of said compression device 12, at a pressure of about 10 bara.

Once dried, the carbon dioxide-enriched residual gas is sent to a separation and purification unit 14 in which the carbon dioxide is separated from the other components of the residual gas during a partial condensation, producing a liquid phase and a gas phase, the carbon dioxide being at least partially condensed in the liquid phase. The separation and purification unit 14 comprises especially a membrane unit (not represented) configured to separate the residual gaseous carbon dioxide in the gas phase from the other gaseous components of the gas phase. Alternatively, the separation and purification unit comprises a membrane unit that separates the carbon dioxide from the other components of the residual gas on its own. By virtue of the separation and purification unit, the carbon dioxide can be captured rather than emitted into the atmosphere, thereby improving the carbon balance of the production of hydrogen.

An installation for production of a standard carbon dioxide-enriched gas can be revamped in order to integrate a condensation by cooling and separation device and an economizer exchanger 7 as described above and to implement a process which is less restrictive from the point of view of condensation.

The process according to the invention is also applicable to autothermal reforming processes and partial oxidation processes, in addition to steam reforming processes.

By virtue of the invention, it is possible to employ a compression and cooling device partially made of carbon steel. Capital expenditure on the compression device is reduced. In addition, reducing the content of condensable components in the synthesis gas and therefore that of the residual gas allows the latter gas to be cooled further during the compression step, thereby saving a lot of energy. In addition, where it is necessary to separate the residual condensable components from the residual gas, drying by the drying unit 13 of the residual gas by adsorption can be carried out at a pressure higher than that at which it is normally carried out, of around 10 bara in the prior art, without the need for a stainless steel compression and cooling device. The drying cost is then reduced and a smaller drying unit can be used. The start-up phase of the process is also less restrictive on the preheating of the installation because the risk of condensation due to too cold a temperature is reduced. Condensing upstream of the PSA unit 1 a portion of the condensable components contained in the synthesis gas also removes certain impurities through the condensates, limiting their quantity in the residual gas. Condensates other than water, which may be present in the synthesis gas, such as methanol or ammonia, can be removed. These impurities or condensates would otherwise have had to be treated by a catalytic unit or by an adsorption drying unit oversized for this purpose.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-15. (canceled)

16. A process for producing a carbon dioxide-enriched gas from a feed synthesis gas comprising at least one condensable component, and especially hydrogen, the process comprising the following steps:
a) introduction into a unit for separation by pressure swing adsorption of a de-saturated synthesis gas obtained from the feed synthesis gas;
b) separation by the pressure swing adsorption separation unit of the de-saturated synthesis gas into a first fraction and a carbon dioxide-enriched residual gas;
c) compression of the residual gas with at least two compression stages and cooling of the compressed residual gas at at least one intermediate compression stage;
characterized in that the process further comprises:
a desaturation step during which at least a portion of the condensable component contained in the feed synthesis gas is condensed, upstream of said pressure swing adsorption separation unit, by cooling to a temperature of less than 10° C., especially less than or equal to 5° C., and separated, producing said de-saturated synthesis gas and at least one condensate;
the feed synthesis gas undergoing heat exchange with the de-saturated synthesis gas so as to heat said de-saturated synthesis gas upstream of the pressure swing adsorption separation unit.

17. The process as claimed in claim 16, wherein the feed synthesis gas comprises between 70% and 80% of hydrogen and between 20% and 30% of other compounds, including carbon dioxide and the condensable component.

18. The process as claimed in claim 16, wherein the condensable component is chosen from water, ammonia and/or methanol.

19. The process as claimed in claim 16, wherein, in the desaturation step, the condensation of the condensable component is performed by cooling of the feed synthesis gas using a refrigerant fluid.

20. The process as claimed in claim 16, wherein the feed synthesis gas undergoes heat exchange with the de-saturated synthesis gas in an economizer exchanger and a minimum temperature difference within the economizer exchanger between the feed synthesis gas and the de-saturated synthesis gas is between 2 and 10° C., especially between 5 and 10° C.

21. The process as claimed in claim 16, comprising a step d) during which the residual gas is dried by adsorption so as to separate residual condensable component from the residual gas.

22. The process as claimed in claim 21, wherein the residual gas is dried during step d), downstream of the compression step c).

23. The process as claimed in claim 21, wherein the residual gas is dried during step d), at an intermediate compression stage.

24. The process as claimed in claim 16, comprising downstream of step c) a step e) during which the carbon dioxide is separated from the residual gas in order to be captured or sequestered.

25. The process as claimed in claim 24, wherein said carbon dioxide is separated, during step e), by partial condensation, the carbon dioxide being at least partially condensed, and/or the carbon dioxide is separated using a membrane, in a membrane unit.

26. The process as claimed in claim 16, comprising the following steps:
measurement of a temperature of the de-saturated synthesis gas,
comparison of the measured temperature of the de-saturated synthesis gas with a minimum setpoint temperature of the de-saturated synthesis gas introduced into the pressure swing adsorption separation unit,
if the measured temperature of the de-saturated synthesis gas is lower than the minimum setpoint temperature, regulation of the temperature of the de-saturated synthesis gas by reduction in the cooling of the feed synthesis gas in at least one feed heat exchanger, arranged upstream of the desaturation step.

27. An installation for production of a carbon dioxide-enriched gas from a feed synthesis gas comprising at least one condensable component and especially hydrogen, the installation comprising:
a pressure swing adsorption separation unit configured to separate a de-saturated synthesis gas, obtained from the feed synthesis gas, into a first fraction and a carbon dioxide-enriched residual gas;
a compression device arranged downstream of the pressure swing adsorption separation unit, the compression device comprising at least two stages for compressing the residual gas and at least one intermediate exchanger for cooling the compressed residual gas at an intermediate compression stage;
characterized in that the installation comprises:
upstream of the pressure swing adsorption separation unit, a condensation by cooling and separation device configured to condense and separate at least a portion of the condensable component contained in the feed synthesis gas and produce the de-saturated synthesis gas and at least one condensate;
an economizer exchanger arranged to bring about heat exchange between the feed synthesis gas and the de-saturated synthesis gas.

28. The installation as claimed in claim 27, comprising a residual gas adsorption drying unit configured to separate residual condensable component from the residual gas.

29. The installation as claimed in claim 27, wherein the condensation by cooling and separation device comprises:
a bi-fluid exchanger comprising a section for circulating the feed synthesis gas and a section for circulating a refrigerant fluid, arranged to be in heat exchange with the section for circulating the feed synthesis gas, to cool the feed synthesis gas, to condense the condensable compounds and to produce the de-saturated synthesis gas and the condensate;
a condensate separation device configured to separate the condensate from the de-saturated synthesis gas.

30. The installation as claimed in claim 27, wherein the economizer exchanger comprises:
a first section for circulating the feed synthesis gas;
a second section for circulating the de-saturated synthesis gas, arranged to be in heat exchange with the first section.
